(19) United States
(12) Patent Application Publication
(10) Pub. No.: US 2006/0281834 A1
(43) Pub. Date: Dec. 14, 2006

(54) Method for preparing microcapsule by miniemulsion polymerization

(76) Inventors: Kyung-Woo Lee, Daejeon (KR); Yang-Seung Jeong, Incheon (KR); Hyun-Chul Ha, Bucheon-si (KR)

Correspondence Address: CANTOR COLBURN, LLP, 55 GRIFFIN ROAD SOUTH, BLOOMFIELD, CT, 06002, US

(21) Appl. No.: 10/563,523

(22) PCT Filed: Jul. 3, 2004
(86) PCT No.: PCT/KR04/01644

§ 371 Date: Jun. 15, 2006

(30) Foreign Application Priority Data
Jul. 3, 2003 (KR) 10-2003-0045056
Aug. 12, 2003 (KR) 10-2003-0055845
Nov. 5, 2003 (KR) 10-2003-0077920
Jan. 19, 2004 (KR) 10-2004-0003651

(51) Int. Cl. C09D 151/00

(52) U.S. Cl. 523/201

(57) ABSTRACT

Provided is a method for preparing uniformly sized and shaped, mono-dispersed microcapsules using miniemulsion polymerization. In microcapsules prepared by the method, a liquid or solid core encapsulated by a polymer shell has 10 to 80% by volume of the microcapsules. Since miniemulsion particles produced at an early stage of the method are stable, an organic material which is well dissolved in monomer particles and has a higher interfacial tension with water, relative to the polymer shell, can be uniformly positioned in polymer particles. Furthermore, when a crosslinking agent is added during the polymerization, single-core microcapsules can be obtained. In addition, use of an oil-soluble initiator can prevent formation of secondary particles and addition of a secondary initiator during the polymerization can increase the yield of the uniformly sized and shaped microcapsules.

### TECHNICAL FIELD

The present invention relates to a -method for preparing microcapsules by miniemulsion polymerization, and more particularly to a method for preparing microcapsules, which includes mixing a monomer, an emulsifier, an ultrahydrophobe, a hydrophobic material, an initiator, preferably an oil-soluble initiator, and deionized water, optionally a hydrophilic comonomer and/or a crosslinking agent used as an auxiliary monomer, to prepare a miniemulsion and polymerizing the miniemulsion. As needed, the method may further include adding a secondary initiator during the xminiemulsion polymerization to allow the miniemulsion polymerization to further proceed. In some cases, the crosslinking agent may be added during the miniemulsion polymerization. The present invention also relates to microcapsules prepared by the method.

### BACKGROUND ARTS

Microcapsules have been implicitly defined as particles ranging from several tens nanometers to several tens microns which contain a core material composed of a liquid or solid molecule surrounded by a shell made of mainly a polymer material, relative to nanocapsules having a particle size of several hundreds nanometers or less. The core material may be selected from drugs, perfumes, catalysts, dyes, and uniform liquid solutions containing the forgoing components. These microcapsules and nanocapsules have various application fields.

Coacervation, interfacial polymerization, and in-situ polymerization are representative methods known for preparation of microcapsules. When needed, their supplemented or modified methods can be used. For example, there is a microcapsule preparation method using a polymer post-treatment (Chem. Soc. Rev., 29, 295, 2000]. According to the method, a water-insoluble polymer, an organic solvent, and a core material are mixed and sufficiently stirred to obtain a uniform solution, followed. by removal of the organic solvent. Examples of patent documents using this method include U.S. Pat. No. 4,384,975 and U.K. Patent No. 1,394,780. Solvent removal by vacuum distillation is disclosed in U.S. Pat. No. 4,384,975 and solvent removal by evaporation is disclosed in U.K. Patent No. 1,394,780. However, there are problems in that the former has a limitation on types of organic materials which can be encapsulated and the latter takes considerable time for microcapsule preparation.

In addition, U.S. Pat. No. 3,891,570 discloses a method for preparing microcapsules by heating a water-soluble dispersion or removal of a polymer solvent under vacuum and U.S. Pat. No. 3,737,337 discloses a method for preparing microcapsules by extracting an organic solvent with water. Preparation of microcapsules by removal of an organic solvent is also disclosed in Polym. Eng. Sci., 1990, 30, 915. However, since these methods are based on removal of an organic solvent, it is impossible to encapsulate a low-temperature volatile material with a low molecular weight of 500 Daltons or less. Therefore, these methods can be applied only in a specific system.

Microcapsules can also be prepared by a suspension-crosslinking method [Polym. Eng. Sci., 1989, 29, 1746]. According to this method, a polymer is dissolved in a solvent and stirred mechanically to obtain suspension particles, followed by polymer crosslinking. Then, produced microcapsules are recovered. However, this method has disadvantages in that appropriate compatibility between the solvent and the polymer is required and the microcapsules may not have a core-shell structure.

Meanwhile, coacervation is a method of forming a permeable polymer coacervate which adjusts the concentration of a core material in response to change in exterior environment under a specific condition [Polym. Eng. Sci., 1990, 30, 905]. When a third solvent is added to a polymer solution, particles which are different in the content of the third solvent between inside and outside of the particles in a specific condition can be obtained. Based on this principle, various substances can be encapsulated in these particles under an appropriate condition. However, preparation of microcapsules by coacervation has disadvantages in that a specific polymer constituting the coacervate must be used, a preparation process is complicated, and a polymer-core material-solvent system is easily broken, thereby forming polymer aggregates.

Interfacial polymerization for forming the shells of microcapsules has also been widely used. Examples of a material constituting the shells of microcapsules include polyurethane and polyamide. For example, Korean Patent No. 0,272,616 discloses a method for preparing microcapsules having a particle size of 1 μm or more and a polyurea shell. However, since a polymer material constituting the shell must be prepared by interfacial polymerization, there is a limitation on the type of the polymer material. Furthermore, finally completed microcapsules have a broad particle size distribution, and a reaction system is in a very diluted state, thereby decreasing the concentration of the microcapsules.

U.S. Pat. No. 5,545,504 discloses miniemulsion polymerization for encapsulating 1 to 30 parts by weight of a heterogeneous polymer. In this method, an inkjet toner substance, which is the heterogeneous polymer, is used as a polymer support to prepare a uniformly sized hybrid substance. However, there is a disadvantage in that only a polymer is contained in a finally obtained substance.

Meanwhile, there are also known various methods for preparing microcapsules having a relatively small particle size of several tens to several hundreds nanometers. An exemplary method is a self-assembly approach. This method is to prepare double-layered, spherical particles from a diluted aqueous solution of an amphiphilic lipid molecule. If the double-layered particles have polymerizable functional groups, microcapsules are produced by polymerization. Even though studies about this method have been continued since 1970, since this method is affected by many process parameters such as synthesis of an amphiphilic block compound and a temperature, there have been very few successful instances [Langmuir, 2000, 16, 1035]. Furthermore, there is a strict limitation on the type of a polymer constituting the shells of the microcapsules.

A self-assembly approach using dendrimer is also known [J. Am. Chem. Soc., 1995, 117, 4417]. An amphiphilic dendrimer tends to form spherical particles by self-assembly at a predetermined temperature and concentration according to its type. Due to a low core density and a high surface density, a dendrimer can form nanocapsules. In this regard, encapsulation of a core material by the dendrimer can produce microcapsules. However, since dendrimer shells of the microcapsules thus produced are not held by a covalent bond, a shell function can be easily lost by change in exterior environment. Furthermore, there are disadvantages in that dendrimer synthesis is difficult and dendrimer-based microcapsules are produced only in a specific condition. In addition, a hyperbranched polymer technique [Angew. Chem. Intl. Ed., 1991, 30, 1178], a reverse-phase amphiphilic dendrimer technique [Angew. Chem. Intl. Ed., 1999, 38, 3552˜] and the like have been reported, but have similar disadvantages.

There is reported a method for preparing hollow microcapsules-using a template. According to disclosure in Angew. Chem. Intl. Ed., 1998, 37, 2201, an amphiphilic polyisoprene-polyacrylic acid block copolymer is self-assembled in an aqueous solution, followed by shell crosslinking by condensation between an amine with two reactive groups and a polyacrylic acid and removal of a polyisoprene core by oxidation with ozone, to prepare hollow nanocapsules. However, there is a serious disadvantage in that the preparation method is complicated and can be applied to only an amphiphilic molecule.

Another method for preparing nanocapsules is an emulsion-diffusion technique disclosed in Drug. Dev. Re., 2002, 57, 18. According to this method, a polymer is dissolved in a solvent to obtain a polymer solution. Then, the polymer solution is added to a solvent-saturated aqueous solution and vigorously stirred in the presence of an emulsifier to perform emulsification. After the emulsification is terminated, addition of a large amount of an aqueous solution induces transfer of the solvent into an aqueous solution phase by chemical equilibrium, thereby producing hollow nanocapsules. However, there is a limitation on the type of a solvent capable of solubilizing most polymers, preparation of a high concentration polymer solution and control of a particle size are difficult, and a preparation process is complicated.

Adv. Colloid. Interface. Science, 2002, 99, 181 discloses a method for encapsulating a hydrocarbon using a non-solvent for a polymer. According to this method, a low molecular weight polymer latex is used as seed particles. When the latex particles are swelled by small quantity of isooctane and then polymerization is performed, spontaneous phase separation occurs with increase of a polymer concentration. As a result, isooctane is encapsulated. However, there is a disadvantage in that this method can be applied to only a reaction system in which initial latex particles can be swelled to some degree and phase separation by increase of a polymer concentration is possible.

There is reported an attempt to prepare microcapsules by miniemulsion polymerization after mixing large amounts of polystyrene (PS) or polymethylmethacrylate (PMMA) and hexadecane which is an ultrahydrophobe [Langmuir, 17, 908, 2001]. However, according to the report, microcapsules are produced only in the presence of a specific initiator and only the ultrahydrophobe is microencapsulated. In addition, in a conventional technique, when a water-soluble monomer, in particular, is used, polymerization is easily performed in a continuous phase. That is, due to polymerization except miniemulsion polymerization, like homogeneous nucleation, polymer particles per se (secondary particles) may be produced as byproducts, in addition to microcapsules.

Prog. Polym. Sci. 2002, 27 689 discloses miniemulsion polymerization for latex preparation, like typical emulsion polymerization. However, unlike typical emulsion polymerization, a liquid monomer is dispersed in water with a homogenizer having strong pulverizability, such as an ultrasonic homogenizer, a Microfluidizer, and Manton-Gaulin homogenizer, to produce particles which are several tens to several hundreds nanometers in size. At this time, instability of small particles that may occur due to the Ostwald ripening effect, is overcome by an osmotic pressure created by dissolving an ultrahydrophobe in miniemulsion particles. Polymerization of the miniemulsion particles thus stabilized produces a polymer latex. Such a stabilization mechanism is based on prevention of the Ostwald ripening effect which occurs with increase of the Kelvin pressure of a liquid medium due to size reduction of emulsion particles. Generally, when a third component, which is sparsely soluble in water, and thus, cannot be transferred to other positions through diffusion via water, is dissolved in monomer particles, the concentration of the third component increases in small particles due to escape of a main component from the small particles, but it decreases in large particles due to inclusion of the main component into the large particles. Due to such a concentration difference in the third component, chemical potential difference in the monomer particles is generated, thereby creating an osmotic pressure. The Ostwald ripening effect is prevented by the osmotic pressure thus created. For reference, the Ostwald Ripening effect is a phenomenon that occurs because small particles are superior to large ones in terms of the solubility of a dispersed compound in a continuous phase. Due to this phenomenon, the small particles undergo transfer of their components into the continuous phase and the large particles absorb these components. As a result, smaller particles disappear and larger particles grow in size to thereby induce the continuous increase of an average particle size.

According to the study reports by Torza and Mason, particle morphology by phase separation between different polymers can be predicted by using the differences of the interfacial tension between each polymer and a continuous phase [J. Coll. Inter. Sci., 1970, 33, 6783]. Particle morphology in an equilibrium state can be predicted by comparing dispersion coefficients calculated based on the interfacial tensions. In most cases, it is reported that encapsulation of a core material occurs when the interfacial tension between a shell material and a continuous phase is lower than that between the core material and the continuous phase.

There is another method for predicting particle morphology based on interface energy, which is more efficient than the above-described interfacial tension based method. This method is based on the principle that particles are shaped toward minimization of interface energy. Even though this method is fundamentally similar to the method suggested by Torza and Mason, there is a difference in that a surface area at an interface is considered in this method. Interface energy is obtained by multiplying a surface area and an interfacial tension. Particles are stabilized toward minimization of interface energy by controlling the two factors, i.e., the surface area and the interfacial tension [Microencapsulation, 1989, 6, 327˜].

### DISCLOSURE OF THE INVENTION

While searching for solutions to these problems, the present inventors found that when a monomer, an emulsifier, an ultrahydrophobe, a low viscosity hydrophobic material, an initiator, preferably an oil-soluble initiator, and deionized water, optionally a hydrophilic comonomer and/or a crosslinking agent used as an auxiliary monomer, are mixed to form a miniemulsion, followed by polymerization (as needed, a secondary initiator may be added during the polymerization to allow the polymerization to further proceed), stability of monomer particles increases by an osmotic pressure created by the ultrahydrophobe, so that substances able to be dissolved in monomer particles are encased in the monomer particles and phase separation between the hydrophobic material and a polymer produced by monomer polymerization occurs to produce microcapsules with a core-shell structure, and completed the present invention.

According to the present invention, as polymerization proceeds, a phase separation by a solubility difference between a hydrophobic material and a product polymer occurs in an accurate, rapid, easy, and spontaneous manner due to low viscosity of the hydrophobic material. Since the hydrophobic material, which is added in the form of a liquid phase, is dissolved in monomer particles but not in a polymer, it can be used as a solvent in the microcapsule preparation method according to the present invention.

According to an aspect of the present invention, there is provided a method for preparing microcapsules comprising the steps of:

(a) mixing a monomer, an emulsifier, an ultrahydrophobe, a hydrophobic material, an initiator, deionized water, optionally a hydrophilic comonomer and/or a crosslinking agent used as an auxiliary monomer, to prepare a miniemulsion;

(b) polymerizing the miniemulsion to prepare the microcapsules; and

(c) optionally, adding a secondary initiator during the miniemulsion polymerization to allow the miniemulsion polymerization to further proceed.

According to a modification of the method, the crosslinking agent may be added during step (a) or (b).

Hereinafter, the microcapsule preparation method according to the present invention will be described in detail.

According to the method of the present invention, the emulsifier may be used in an amount of 0.01 to 5.0 parts by weight, the ultrahydrophobe in an amount of 0.1 to 10 parts by weight, the hydrophobic material in an amount of 10 to 300 parts by weight, the crosslinking agent in an amount of 0.0 to 10 parts by weight, the initiator in an amount of 0.01 to 3 parts by weight, the hydrophilic comonomer in an amount of 0.01 to 10 parts by weight, and the secondary initiator in an amount of 0.01 to 1 part by weight, based on 100 parts by weight of the monomer.

The miniemulsion polymerization may be performed at a temperature from 25 to 160° C., and preferably from 40 to 90° C. Time required for the polymerization may vary according to the types of used monomers and a polymerization rate. However, the polymerization may be performed for 3 to 24 hours, preferably 4 to 10 hours, and more preferably 4 to 8 hours.

In the method of the present invention, the initiator that can be used to initiate the polymerization may be one or more selected from the group consisting of peroxides, persulfates, azo compounds, and redox compounds. Specifically, the initiator may be inorganic or organic peroxides such as hydrogen peroxide (H₂O₂), di-tert-butyl peroxide, cumene hydroperoxide, didyclohexyl percarbonate, tert-butyl hydroperoxide, and p-menthane hydroperoxide; azo compounds such as azobisisobutyronitrile; persulfates such as ammonium persulfate, sodium persulfate, and potassium persulfate; potassium perphosphate; sodium perborate; or redox compounds.

Preferably, an oil-soluble initiator may be used as the initiator of the present invention. The oil-soluble initiator serves to prevent formation of secondary particles free of cores, thereby ensuring uniformly sized and shaped microcapsules. As used herein, the term “secondary particles” refer to hydrophobic material-free particles prepared by monomer polymerization in an aqueous phase and spontaneous particle formation, unlike latex particles prepared by polymerization of hydrophobic material-containing monomer particles obtained by homogenization. Since these secondary particles may deteriorate the characteristics of a final product due to the absence of a hydrophobic material, it is necessary to prevent formation of the secondary particles. The oil-soluble initiator is present only within monomer particles. Therefore, polymerization of a monomer that may be present in an aqueous phase can be prevented, thereby preventing formation of secondary particles.

To prevent formation of secondary particles, it is preferable to select the oil-soluble initiator that is dissolved in a monomer but not in water. In this respect, the oil-soluble initiator is advantageously a material having 0.5 g/kg or less, and preferably 0.02 g/kg or less of solubility in 25° C. water. The oil-soluble initiator may be one or more selected from peroxides, azo compounds, and redox compounds, but is not limited thereto.

In the present invention, the initiator may be used in an amount of 0.01 to 3 parts by weight, based on 100 parts by weight of the monomer. If the content of the initiator is less than 0.01 parts by weight, a polymerization rate may decrease. On the other hand, if it exceeds 3 parts by weight, the initiator may act as an impurity after the polymerization.

Microcapsules prepared according to the method of the present invention contain a core material surrounded by a polymer shell. The core material exists as a separate phase such as a liquid phase or a solid phase. In the present invention, the hydrophobic material is used as the core material.

To exist as a separate phase within a polymer, it is preferable to select the hydrophobic material which is compatible with a monomer but incompatible with a polymer. The interfacial tension between the hydrophobic material and water must be higher than that between a final polymer constituting a shell and water. The hydrophobic material is not limited to a material having solubility lower than the polymer and may be selected from most organic materials having compatibility with a monomer.

Examples of the hydrophobic material include C₄ -C₂₀ aliphatic or aromatic hydrocarbons and their isomers such as hexane, heptane, cyclohexane, octane, nonane, decane, benzene, toluene, and xylene; C₁₀ -C₂₀ aliphatic or aromatic alcohols; C₁₀-C₂₀ aliphatic or aromatic esters; C₁₀-C₂₀ aliphatic or aromatic ethers; silicone oils, natural and synthetic oils, but are not limited thereto. These compounds mentioned as the hydrophobic material may be used alone or in combination. The hydrophobic material may also be an ultrahydrophobe as will be described later.

Preferably, the hydrophobic material is used in an amount of 10 to 300 parts by weight, based on 100 parts by weight of the monomer. If the content of the hydrophobic material is less than 10 parts by weight, very small cores that cannot function as cores of microcapsules may be formed. On the other hand, if it exceeds 300 parts by weight, the ratio of a polymer shell to a core may be low, which makes it difficult to maintain particle shapes.

In the miniemulsion preparation according to the method of the present invention, the ultrahydrophobe serves to stabilize monomer particles. The ultrahydrophobe stabilizes miniemulsion particles composed of the monomer(s) and the hydrophobic material using an osmotic pressure. Finally, the polymerization occurs without a material exchange between the miniemulsion particles. As the polymerization proceeds, a phase separation occurs between a polymer and the hydrophobic material, thereby producing microcapsules.

To stabilize miniemulsion particles by an osmotic pressure, the ultrahydrophobe may be a material having 5×10⁻⁵ g/kg or less, and preferably 5×10⁻⁶ g/kg or less of solubility in 25° C. water. Specifically, the ultrahydrophobe may be one or more selected from the group consisting of C₁₂˜C₂₀ aliphatic hydrocarbons, C₁₂˜C₂₀ aliphatic alcohols, C₁₂˜C₂₀ alkyl acrylates, C₁₂˜C₂₀ alkyl mercaptans, organic dyes, fluorinated alkanes, silicone oil compounds, natural oils, synthetic oils, oligomers with a molecular weight of 1,000 to 500,000, and polymers with a molecular weight of 1,000 to 500,000.

Illustrate examples of the ultrahydrophobe include, but are not limited to, hexadecane, heptadecane, octadecane, cetyl alcohol, isopropyl laurate, isopropyl palmitate, hexyl laurate, isopropyl myristate, myristyl myristate, cetyl myristate, 2-octyldecyl myristate, isopropyl palmitate, 2-ethylhexyl palmitate, butyl stearate, decyl oleate, 2-octyldodecyl oleate, polypropylene glycol monooleate, neopentyl glycol 2-ethylhexanoate, polyol ester oil, isostearate, triglyceride, coco fatty acid triglyceride, almond oil, apricot kernel oil, avocado oil, theobroma oil, carrot seed oil, castor oil, citrus seed oil, coconut oil, corn oil, cottonseed oil, cucumber oil, egg oil, jojoba oil, lanolin oil, linseed oil, mineral oil, mink oil, olive oil, palm oil, kernel oil, peach kernel oil, peanut oil, rapeseed oil, safflower oil, sesame oil, shark liver oil, soybean oil, sunflower seed oil, sweet almond oil, beef tallow, mutton oil, turtle oil, vegetable oil, whale oil, wheat germ oil, organic silicon, siloxane, n-dodecyl mercaptan, t-dodecyl mercaptan, and hexafluorobenzene. These compounds mentioned as the ultrahydrophobe may be used alone or in combination.

More preferably, the ultrahydrophobe is hexadecane or cetyl alcohol.

Preferably, the ultrahydrophobe is used in an amount of 0.1 to 10 parts by weight, based on 100 parts by weight of the monomer. If the content of the ultrahydrophobe is less than 0.1 parts by weight, a stable miniemulsion may not be obtained. On the other hand, if it exceeds 10 parts by weight, the ultrahydrophobe may act as an impurity after the polymerization. The ultrahydrophobe may also be encapsulated. However, when the ultrahydrophobe is used in a small amount, it is incorporated in each polymer chain. When the ultrahydrophobe exceeds its dissolution limit, a phase separation between the ultrahydrophobe and the polymer occurs, thereby encapsulating the ultrahydrophobe.

Microcapsules prepared according to the method of the present invention are composed of a polymer shell encapsulating the hydrophobic material used as a core material. The polymer shell is derived from the following monomer selected according to the type of the hydrophobic material to be encapsulated. The polarity of a polymer and the interfacial tension between the polymer and water can vary according to the type of the monomer. There are reported many polymers derived from free-radically polymerizable monomers.

The monomer forming the polymer shell is a free-radically polymerizable ethylenically unsaturated monomer. It is preferable to select the monomer so that the interfacial tension between a product polymer and water is smaller than that between a core material and water. The monomer may be one or more selected from the group consisting of methacrylate derivatives, acrylate derivatives, acrylic acid derivatives, methacrylonitriles, ethylenes, butadienes, isoprenes, styrenes, styrene derivatives, acrylonitrile derivatives, vinylester derivatives, and halogenated vinyl derivatives, and mercaptan derivatives.

Examples. of the monomer include, but are not limited to, styrene, α-methyl styrene, p-nitro styrene, ethylvinylbenzene, vinylnaphthalene, methyl methacrylate, ethyl acrylate, hydroxyethyl methacrylate, n-butyl methacrylate, isobutyl acrylate, isobutyl methacrylate, n-hexyl acrylate, n-hexyl methacrylate, ethylhexyl acrylate, ethylhexyl methacrylate, n-octyl acrylate, n-octyl methacrylate, decyl acrylate, decyl methacrylate, dodecyl acrylate, dodecyl methacrylate, stearyl acrylate, stearyl methacrylate, cyclohexyl acrylate, cyclohexyl methacrylate, 4-tert-butylcyclohexyl methacrylate, benzyl acrylate, benzyl methacrylate, phenylethyl acrylate, phenylethyl methacrylate, phenylpropyl acrylate, phenylpropyl methacrylate, phenylnonyl acrylate, phenylnonyl methacrylate, 3-methoxybutyl acrylate, 3-methoxybutyl methacrylate, butoxyethyl acrylate, butoxyethyl methacrylate, diethylene glycol monoacrylate, diethylene glycol monomethacrylate, triethylene glycol monoacrylate, triethylene glycol monomethacrylate, tetraethylene glycol monoacrylate, tetraethylene glycol monomethacrylate, furfuryl acrylate, furfuryl methacrylate, tetrahydrofurfuryl acrylate, tetrahydrofurfuryl methacrylate, acrylonitrile, vinyl acetate, vinyl pivalate, vinyl propionate, vinyl 2-ethylhexanoate, vinyl neononanoate, and vinyl neodecanoate. These compounds mentioned as the monomer may be used alone or in combination.

The crosslinking agent used as an auxiliary monomer in the microcapsule preparation method of the present invention serves to adjust the strength of a polymer shell and diffusion of a core material. The use and content of the crosslinking agent are determined by a desired strength of the polymer shells of the microcapsules and a desired diffusion rate of the core material.

Preferably, the crosslinking agent is a monomer that can be copolymerized with the monomer forming the polymer shell and has two or more unsaturated bonds.

The crosslinking agent may be one or more selected from the group consisting of allyl methacrylate, ethylene glycol dimethacrylate, ethylene glycol diacrylate, butanediol diacrylate, butanediol dimethacrylate, neopentyl glycol dimethacrylate, hexanediol dimethacrylate, triethylene glycol dimethacrylate, tetraethylene glycol dimethacrylate, trimethylolpropane trimethacrylate, pentaerythritol tetramethacrylate, and divinylbenzene.

The crosslinking agent may be used in an amount of 0 to 10 parts by weight, and preferably 0.1 to 10 parts by weight, based on 100 parts by weight of the monomer. If the content of the crosslinking agent exceeds 10 parts by weight, large amounts of floating materials may be generated due to phase instability.

The crosslinking agent may be added at the time of the miniemulsion preparation. However, in view of the use of a final product, the crosslinking agent may be added during the miniemulsion polymerization. The crosslinking agent may be added at a time or continuously. When a miniemulsion has a particle size as small as 500 nm or less, microcapsules can be created regardless of the addition time of the crosslinking agent. However, when the miniemulsion has a very large particle size, the addition of the crosslinking agent at the time of the miniemulsion preparation may form a network structure between chains of a polymer prior to phase separation between the polymer and the hydrophobic material. As a result, microcapsules may have a multi-pore structure in which several small pores are present. That is, when the sizes of miniemulsion particles are too large to form a core-shell structure, the addition of the crosslinking agent during the miniemulsion polymerization can form single-core microcapsules.

The crosslinking agent may be added when a monomer to polymer conversion is 20 to 90%, and preferably 40 to 80%.

In the microcapsule preparation method of the present invention, the secondary initiator may be added during the miniemulsion polymerization to prevent lowering of the monomer to polymer conversion that may be caused when the oil-soluble initiator is used.

Preferably, the secondary initiator may be added when a monomer to polymer conversion is 50 to 95%, and more preferably 65 to 90%.

The secondary initiator may be one or more selected from the group consisting of peroxides, persulfates, azo compounds, and redox compounds. Specifically, the secondary initiator may be potassium perphosphate; sodium perborate; persulfates such as ammonium persulfate, sodium persulfate, and potassium persulfate; inorganic or organic peroxides such as H₂O₂, di-tert-butyl peroxide, cumene hydroperoxide, dicyclohexyl percarbonate, tert-butyl hydroperoxide, and p-menthane hydroperoxide; azo compounds such as azobisisobutyronitrile; or redox compounds, but is not limited thereto. These compounds mentioned as the secondary initiator may be used alone or in combination.

Preferably, the secondary initiator is used in an amount of 0.01 to 1 part by weight, based on 100 parts by weight of the monomer. If the content of the secondary initiator is less than 0.01 parts by weight, a polymerization rate may be decreased. On the other hand, if it exceeds 1 part by weight, the secondary initiator_may act as an impurity after the polymerization.

The use of the secondary initiator in the method of the present invention can increase the yield of uniformly sized and shaped microcapsules without using a separate subsequent process.

In the microcapsule preparation method of the present invention, the hydrophilic comonomer is used to increase the hydrophilicity of a polymer produced by copolymerization with the monomer so that the hydrophobic material used as a core material is stably encapsulated by a polymer shell.

As the hydrophilic comonomer, there may be used a compound copolymerizable with the monomer, preferably a compound compatible with the monomer. The hydrophilic comonomer serves to impart hydrophilicity to a polymer during phase separation between the hydrophobic material and the polymer. Therefore, the polymer is easily phase-separated from the ultrahydrophobe and the hydrophobic material, thereby forming an interface with a dispersion medium such as water, so that the polymer constitutes an outer shell and the hydrophobic material constitutes an inner core. The hydrophilic comonomer is optionally used and its use and content are determined by the type of the monomer and the hydrophilic material.

For example, the hydrophilic comonomer may be an unsaturated carboxylic acid such as acrylic acid, methacrylic acid, itaconic acid, crotonic acid, fumaric acid, and maleic acid; or an unsaturated polycarboxylic acid alkyl ester having at least one carboxyl group such as itaconic acid monoethyl ester, fumaric acid monobutyl ester, and maleic acid monobutyl ester. These compounds mentioned as the hydrophilic comonomer may be used alone or in combination.

Preferably, the hydrophilic comonomer is used in an amount of 0.01 to 10 parts by weight, based on 100 parts by weight of the monomer. If the content of the hydrophilic comonomer is less than 0.01 parts by weight, hydrophilicity may not be imparted to a polymer shell, which makes it impossible to form a stable core-shell structure. On the other hand, if it exceeds 10 parts by weight, a large amount of the monomer may be dissolved in an aqueous phase and then polymerized, thereby increasing generation of secondary particles.

In the microcapsule preparation method of the present invention, an emulsifier, deionized water, and other additives that can be commonly used in microcapsule preparation can be used in an appropriate amount without departing from the spirit and scope of the present invention.

The emulsifier as used herein may be one or more selected from the group consisting of a non-ionic emulsifier, a cationic emulsifier, an anionic emulsifier, and an amphiphilic emulsifier. Specifically, the emulsifier may be one or more selected from the group consisting of an anionic emulsifier such as sulfonates, carboxylic acids, succinates, sulfur succinates, and metal salts thereof, for example alkylbenzenesulfonic acid, sodium alkylbenzenesulfonate, alkylsulfonic acid, sodium alkylsulfonate, sodium polyoxyethylenenonylphenylether sulfonate, sodium stearate, sodium dodecyl sulfate, sodium lauryl sulfate, sodium dodecyl succinate, and abietic acid; a cationic emulsifier such as higher amine halogenides, quaternary ammonium salts, and alkylpyridinium salts; a non-ionic emulsifier such as polyvinylalcohol and polyoxyethylenenonylphenylether; and an amphiphilic emulsifier, but is not limited thereto.

Preferably, the emulsifier is used in an amount of 0.01 to 5.0 parts by weight, based on 100 parts by weight of the monomer. If the content of the emulsifier is less than 0.01 parts by weight, a stable miniemulsion may not be obtained. On the other hand, if it exceeds 5.0 parts by weight, emulsion particles may be decreased, thereby creating secondary particles. However, the content of. the emulsifier used must be determined by particle characteristics, such as particle size, of microcapsules.

In the miniemulsion preparation according to the present invention, there may be used a homogenizer generating a high energy, such as an ultrasonic generator, a Microfluidizer, or a Manton-Gaulin homogenizer, to prepare small miniemulsion particles. If necessary, prior to miniemulsion preparation using a homogenizer, an emulsion may be prepared using a mechanical stirrer such as Turrax (Ika Laboratory T25 Basic).

The above and other objects of the present invention can be accomplished by non-limiting embodiments of the present invention as will be described hereinafter.

Therefore, according to an embodiment of the present invention, there is provided a method for preparing microcapsules comprising the steps of:

(a) mixing a monomer, an emulsifier, an ultrahydrophobe, a hydrophobic material, an initiator, and deionized water, to prepare a miniemulsion; and

(b) polymerizing the miniemulsion to prepare the microcapsules.

According to another embodiment of the present invention, there is provided a method for preparing microcapsules comprising the steps of:

(a) mixing a monomer, an emulsifier, an ultrahydrophobe, a hydrophobic material, a crosslinking agent, an initiator, and deionized water, to prepare a miniemulsion; and

(b) polymerizing the miniemulsion to prepare the microcapsules.

According to still another embodiment of the present invention, there is provided a method for preparing microcapsules comprising the steps of:

(a) mixing a monomer, an emulsifier, an ultrahydrophobe, a hydrophobic material, a hydrophilic comonomer, an initiator, and deionized water, to prepare a miniemulsion; and

(b) adding a crosslinking agent during polymerizing the miniemulsion to prepare the microcapsules.

According to further embodiment of the present invention, there is provided a method for preparing microcapsules comprising the steps of:

(a) mixing a monomer, an emulsifier, an ultrahydrophobe, a hydrophobic material, a hydrophilic comonomer, a crosslinking agent, an oil-soluble initiator, and deionized water, to prepare a miniemulsion; and

(b) polymerizing the miniemulsion to prepare the microcapsules.

According to yet another embodiment of the present invention, there is provided a method for preparing microcapsules comprising the steps of:

(a) mixing a monomer, an emulsifier, an ultrahydrophobe, a hydrophobic material, a hydrophilic comonomer, a crosslinking agent, an oil-soluble initiator, and deionized water, to prepare a miniemulsion;

(b) polymerizing the miniemulsion; and

(c) adding a secondary initiator during the polymerization.

Microcapsules prepared by the method of the present invention are in the form of latex with a particle size of 100 to 2,500 nm and a shell thickness of 10 to 1,000 nm. The volume of a liquid or solid core material encapsulated by the shell may be 10 to 80%, based on the total particle volume.

### BRIEF DESCRIPTION OF DRAWINGS

FIGS. 1 through 3 are transmission electron microscopic (TEM) images of polymers prepared in Examples 1 through 3, respectively;

FIGS. 4 through 6 are TEM images of polymers prepared in Examples 7 through 9, respectively; and

FIGS. 7 and 8 are TEM images of polymers prepared in Examples 10 and 11.

### MODES FOR CARRYING OUT THE INVENTION

Hereinafter, the present invention will be described more specifically by Examples but the present invention is not limited to or by them.

### EXAMPLES 1 THROUGH 3

All components were mixed according to composition ratios presented in Table 1 below and added to a Microfluidizer which is a homogenizer to obtain miniemulsion particles. The miniemulsion particles thus obtained were heated in a polymerization reactor at 65° C. under a nitrogen atmosphere for 5 hours in a batch process to give latexes. Properties of the latexes thus obtained were analyzed and the analysis results are presented in Table 1 below.

### COMPARATIVE EXAMPLES 1 AND 21

Latexes were prepared in the same manner as in Example 1 according to composition ratios presented in Table 1 below and a property analysis for the latexes was performed. The analysis results are presented in Table 1 below.

TABLE 1
Latex compositions and properties

| | | | Exam. | Exam. | Exam. | Comp. | Comp. |
|---|---|---|---|---|---|---|---|
| Section | | | 1 | 2 | 3 | 1 | 2 |
| Component | Monomer | Methylmethacrylate | 100 | — | 100 | 100 | — |
| (pbw) | | Styrene | — | 100 | — | — | 100 |
| | Ultrahydrophobe | Hexadecane | 3 | 3 | 3 | 3 | 3 |
| | Hydrophobic | Hexane | 50 | 100 | 120 | — | — |
| | material | | | | | | |
| | Emulsifier | Sodium | 0.2 | 0.2 | 0.4 | 0.2 | 0.1 |
| | | dodecylsulfate | | | | | |
| | Initiator | Lauryl peroxide | 0.1 | 0.1 | — | 0.1 | — |
| | | Potassium | — | — | 0.1 | — | 0.1 |
| | | persulfate | | | | | |
| | Crosslinking | Butanediol | 3 | 3 | 3 | 3 | 3 |
| | agent | dimethacrylate | | | | | |

| | | | | | |
|---|---|---|---|---|---|
| Deionized water | 400 | 400 | 400 | 400 | 400 |

| | | | | | |
|---|---|---|---|---|---|
| Conversion (%) | 98.5 | 95.1 | 94.4 | 97.3 | 95.3 |
| Mv (nm) | 540 | 545 | 222 | 880 | 954 |
| Mn (nm) | 397 | 370 | 185 | 134 | 698 |
| S.D (nm) | 110 | 125 | 42 | 725 | 254 |
| Pore formation | ◯ | ◯ | ◯ | X | X |

Exam.: Example,
Comp.: Comparative Example
pbw: Parts by weight,
Mv: Volume average particle size,
Mn: Number average particle size,
S.D: Standard deviation of particle size distribution

In comparison between Examples 1 through 3 and Comparative Examples 1 and 2, it can be seen that creation of microcapsules is determined by a use of a hydrophobic material. In connection with the latexes of Comparative Examples 1 and 2 in which hexane as a hydrophobic material was absent, no cores were created.

### EXAMPLES 4 THROUGH 9

### Preparation of Microcapsules by Addition of Crosslinking Agent During Miniemulsion Polymerization

### EXAMPLES 4 THROUGH 9

All components except a crosslinking agent were mixed according to composition ratios presented in Table 2 below and added to a Microfluidizer which is a homogenizer to obtain miniemulsion particles. The miniemulsion particles thus obtained were heated in a polymerization reactor at 90° C. under a nitrogen atmosphere in a batch process. At this time, the crosslinking agent was added and the resultant solution was incubated for 10 hours to give latexes. Properties of the latexes thus obtained were analyzed and the analysis results are presented in Table 2 below.

TABLE 2
Latex compositions and properties

| | | | Exam. | Exam. | Exam. | Exam. | Exam. | Exam. |
|---|---|---|---|---|---|---|---|---|
| Section | | | 4 | 5 | 6 | 7 | 8 | 9 |
| Component | Monomer | Styrene | 100 | 100 | 100 | 100 | 100 | 100 |
| (pbw) | Hydrophilic | Acrylic acid | — | — | 3 | 3 | 3 | 3 |
| | comonomer | | | | | | | |
| | Crosslinking | Butanediol | 3 | 3 | 3 | 3 | 3 | 3 |
| | agent | dimethacrylate | | | | | | |
| | Ultrahydrophobe | Hexadecane | 3.6 | 3.6 | 3.6 | 3.6 | 3.6 | 3.6 |
| | Hydrophobic | Isooctane | 50 | 50 | 50 | 50 | 50 | 50 |
| | material | | | | | | | |
| | Initiator | Benzoylperoxide | 0.5 | 0.5 | 0.5 | 0.5 | 0.5 | 0.5 |
| | Emulsifier | Aerosol OT | 0.3 | 0.05 | 0.05 | 0.05 | 0.05 | 0.05 |

| | | | | | | |
|---|---|---|---|---|---|---|
| Deionized water | 200 | 200 | 200 | 200 | 200 | 200 |

| | | | | | | |
|---|---|---|---|---|---|---|
| Addition time of crosslinking agent | 0 | 0 | 0 | 40 | 60 | 75 |
| (Conversion (%)) | | | | | | |
| Particle morphology | Core- | Single | Multi- | Core- | Core- | Core- |
| | shell | core | pore | shell | shell | shell |

Exam.: Example,
pbw: parts by weight

Generally, as the particle size of a miniemulsion increases, a polymer phase separation distance from a hydrophobic material increases, which renders complete phase separation of a high viscosity polymer intermediate difficult. For this reason, a polymer intermediate having a network structure due to a crosslinking agent used to maintain a particle strength may form a multi-pore structure, instead of a core-shell structure. In this respect, to maintain a good shell strength and a core-shell structure, a crosslinking agent can be added during miniemulsion polymerization, like in Examples 7 through 9. Meanwhile, due to a large interfacial tension between a product polymer and water, a miniemulsion having a large particle size of more than 1 μm can create microcapsules with a non-uniform shell and a poorly distributed core during the polymerization. This problem can be solved by addition of a hydrophilic comonomer that serves to decreases an interfacial tension between a polymer and water, thereby forming a core-shell structure.

### EXAMPLES 10 THROUGH 12

### Preparation of Microcapsules Using Hydrophilic Comonomer and Oil-Soluble Initiator

### EXAMPLES 10 THROUGH 12

All components were mixed according to composition ratios presented in Table 3 below and added to a homogenizer to obtain a miniemulsion. The miniemulsion thus obtained were heated in a polymerization reactor at 90° C. under a nitrogen atmosphere for 10 hours in a batch process to give latexes. Properties of the latexes thus obtained were analyzed and the analysis results are presented in Table 3 below.

### COMPARATIVE EXAMPLE 3

Latex was prepared in the same manner as in Example 10 except that a water-soluble initiator was used instead of an oil-soluble initiator and then centrifuged. The centrifugation result is presented in Table 3 below.

TABLE 3
Latex compositions and properties

| | | | Exam. | Exam. | Exam. | Comp. |
|---|---|---|---|---|---|---|
| Section | | | 10 | 11 | 12 | 3 |
| Component | Monomer | Styrene | 100 | 100 | 100 | 100 |
| (parts by | Crosslinking | Butanediol | 3 | 3 | 3 | 3 |
| weight) | agent | dimethacrylate | | | | |
| | Hydrophilic | Methacrylic acid | 5 | 5 | 5 | 5 |
| | comonomer | | | | | |
| | Ultrahydrophobe | Hexadecane | 3.6 | 3.6 | 3.6 | 3.6 |
| | Hydrophobic | Isooctane | 50 | 50 | 50 | 50 |
| | material | | | | | |
| | Oil-soluble | Benzoylperoxide | 0.5 | 0.5 | 0.5 | X |
| | initiator | | | | | |
| | Water-soluble | Potassium persulfate | X | X | X | 0.5 |
| | initiator | | | | | |
| | Emulsifier | Sodium laurylsulfate | X | 0.1 | X | X |
| | | Aerosol OT | 0.1 | X | 0.1 | 0.1 |
| | Deionized water | | 200 | 200 | 200 | 200 |

| | | | | |
|---|---|---|---|---|
| Ratio of supernatant after centrifugation (%) | 98.32 | 98.71 | 97.91 | 66.78 |

Exam.: Example,
Comp.: Comparative Example

In Examples 10 through 12 in which benzoylperoxide was used as an oil-soluble initiator, uniformly sized and stable microcapsules were obtained without creating small-sized secondary particles containing no a hydrophobic material.

### EXAMPLES 13 THROUGH 15

### Preparation of Microcapsules Using Secondary Initiator

### EXAMPLES 13 THROUGH 15

All components except a secondary initiator were mixed according to composition ratios presented in Table 4 below and added to a Microfluidizer which is a homogenizer to obtain a miniemulsion. The miniemulsion thus obtained were heated in a polymerization reactor at 90° C. under a nitrogen atmosphere for 10 hours in a batch process. The secondary initiator was added during the polymerization and the resultant solution was incubated for 2 hours to give latexes.

TABLE 4
Latex compositions and properties

| | | | Example | Example | Example |
|---|---|---|---|---|---|
| Section | | | 13 | 14 | 15 |
| Component | Hydrophobic | Isooctane | 65 | 65 | 65 |
| (parts by | material | | | | |
| weight) | Monomer | Styrene | 100 | 100 | 100 |
| | Crosslinking | Butanediol dimethacrylate | 5 | 5 | 3 |
| | agent | | | | |
| | Hydrophilic | Methacrylic acid | 3 | 3 | 3 |
| | monomer | | | | |
| | Ultrahydrophobe | Hexadecane | 3.6 | 3.6 | 3.6 |
| | Oil-soluble | Benzoylperoxide | 0.5 | 0.5 | 0.5 |
| | initiator | | | | |
| | Secondary | Potassium persulfate | 0.2 | 0.2 | 0.4 |
| | initiator | | | | |
| | Emulsifier | Sodium laurylsulfate | X | 0.1 | X |
| | | Aerosol OT | 0.1 | X | 0.1 |

| | | | |
|---|---|---|---|
| Deionized water | 200 | 200 | 200 |

| | | | |
|---|---|---|---|
| Total conversion (%) | 99.87 | 100 | 100 |
| Ratio of supernatant after centrifugation (%) | 98.23 | 97.98 | 98.71 |

### EXPERIMENTAL EXAMPLES

Measurement of Average Particle Size and Particle Size Distribution of Latexes

The particle sizes and particles size distribution of the above-obtained latexes were measured using a particle size analyzer (Microtrac UPA150) and the results are presented in Table 1 above.

Transmission Electron Microscopy (TEM)

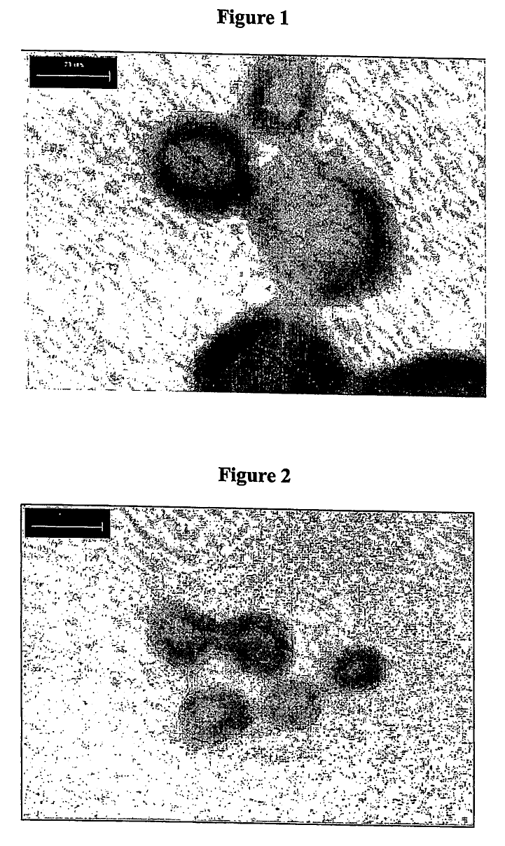

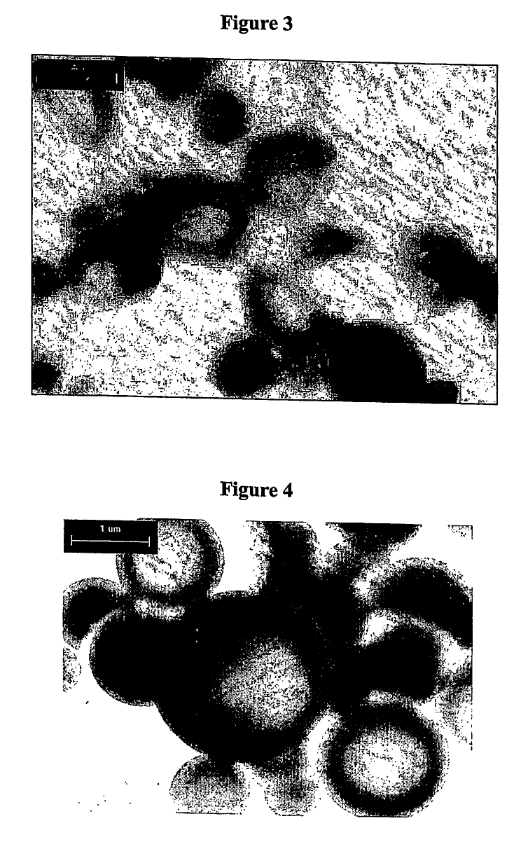

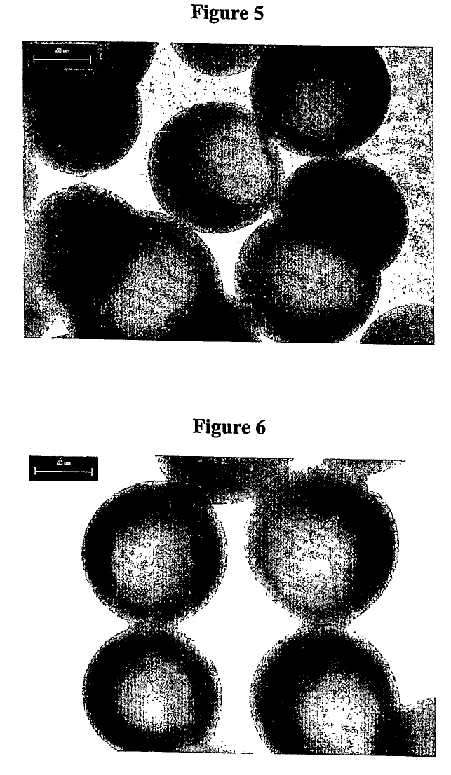

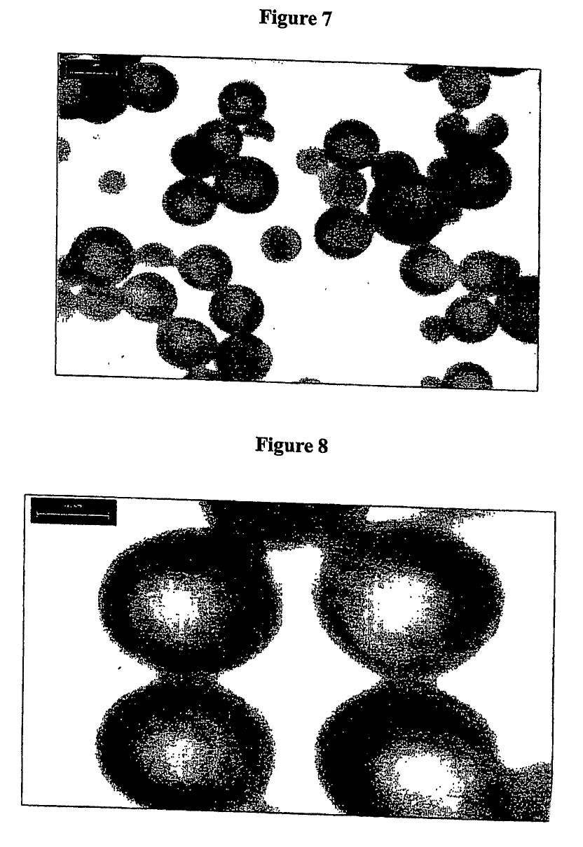

Particle morphology of the above-obtained latexes was observed using TEM and the observation results are shown in FIGS. 1 through 8. As used herein, the term “latex(es)” indicates a dispersion of polymer particles, an emulsifier, and the like, in water.

The polymer latexes prepared according to the present invention had stable and uniform miniemulsion particles.

As shown in FIGS. 1 through 8, a hydrophobic material was contained in uniformly sized microcapsules.

In addition, the polymer latexes prepared in Examples 7 through 9, in which a crosslinking agent was added during polymerization, had a stable single core, as shown in FIGS. 4 through 6.

Identification of Secondary Particles by Centrifugation

The latexes prepared in Examples 10 through 15 were centrifuged at 15,000 rpm for one hour to separate a supernatant part and a precipitate part. The ratios of supernatant parts are presented in Tables 3 and 4.

When latexes are centrifuged, particles containing a hydrophobic material are floated because of their density lower than water to constitute a supernatant part and secondary particles containing no hydrophobic materials are precipitated because of their density higher than water. Based on this principle, presence of secondary particles can be determined. As shown in Table 3, in connection with the latexes prepared in Examples 10 through 12 in which an oil-soluble initiator was used, the ratio of a supernatant part was high. This means that polymerization with an oil-soluble initiator can prevent formation of core-free secondary particles, thereby producing uniformly sized and shaped microcapsules.

Monomer to Polymer Conversion

In the latexes prepared in Examples 13 through 15, monomer to polymer conversions were measured and the results are presented in Table 4.

As shown in Table 4, the latexes of Examples 13 through 15 were prepared by mixing a hydrophobic material, a monomer, a crosslinking agent, a hydrophilic comonomer, an ultrahydrophobe, an emulsifier, and deionized water, to obtain a miniemulsion, and adding a secondary initiator during polymerizing the miniemulsion in the presence of an oil-soluble initiator. In the latexes thus prepared, the total conversion of monomer to polymer was about 100%. This means that after microcapsule preparation, few monomers remained on the polymer. Therefore, a separate subsequent process for removing a residual monomer is not required.

### INDUSTRIAL APPLICABILITY

As apparent from the above description, according to a method for preparing microcapsules of the present invention, miniemulsion particles prepared at an early stage of the method are stabilized by an osmotic pressure generated by an ultrahydrophobe. Therefore, a hydrophobic material which is soluble in monomer particles but not in a polymer, can be encapsulated which makes it possible to produce spherical microcapsules. Furthermore, since a core material encapsulated in the microcapsules of the present invention is not particularly limited, the microcapsules can be used in various fields. That is, various functional substances such as a pharmacological substance and a pigment substance can be used as a core material. Also, an easily removable lower molecular material can also be used as a core material, thereby producing hollow microcapsules.

Addition of a crosslinking agent during polymerization can prevent formation of secondary particles, thereby producing uniformly sized and shaped microcapsules.

In addition, addition of a secondary initiator during polymerization can produce uniformly sized and shaped microcapsules in high yield without a separate subsequent process.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for preparing microcapsules comprising the steps of:
(a) mixing a free-radically polymerizable and ethylenically unsaturated monomer, an emulsifier, an ultrahydrophobe, a hydrophobic material, an initiator and deionized water, to prepare a miniemulsion; and
(b) polymerizing the miniemulsion to prepare the microcapsules.

2. A method for preparing microcapsules comprising the steps of:
(a) mixing a free-radically polymerizable and ethylenically unsaturated monomer, an emulsifier, an ultrahydrophobe, a hydrophobic material, a crosslinking agent, an initiator and deionized water, to prepare a miniemulsion; and
(b) polymerizing the miniemulsion to prepare the microcapsules.

3. A method for preparing microcapsules comprising the steps of:
(a) mixing a free-radically polymerizable and ethylenically unsaturated monomer, an emulsifier, an ultrahydrophobe, a hydrophobic material, an initiator and deionized water, to prepare a miniemulsion; and
(b) adding a crosslinking agent during polymerizing the miniemulsion to prepare the microcapsules.

4. A method for preparing microcapsules comprising the steps of:
(a) mixing a free-radically polymerizable and ethylenically unsaturated monomer, an emulsifier, an ultrahydrophobe, a hydrophobic material, a hydrophilic comonomer, a crosslinking agent, an oil-soluble initiator and deionized water, to prepare a miniemulsion;
(b) polymerizing the miniemulsion to prepare the microcapsules.

5. A method for preparing microcapsules comprising the steps of:
(a) mixing a free-radically polymerizable and ethylenically unsaturated monomer, an emulsifier, an ultrahydrophobe, a hydrophobic material, a hydrophilic comonomer, a crosslinking agent, an oil-soluble initiator and deionized water, to prepare a miniemulsion;
(b) polymerizing the miniemulsion; and
(c) adding a secondary initiator during the polymerization.

6. The method of claim 1, wherein the hydrophobic material is compatible with the free-radically polymerizable and ethylenically unsaturated monomer and incompatible with a polymer constituting final shells of the microcapsules, and an interfacial tension between the hydrophobic material and water is larger than that between the polymer and water.

7. The method of claim 6, wherein the hydrophobic material is one or more selected from the group consisting of aliphatic and aromatic hydrocarbons of C₄-C₂₀ and isomers thereof, aliphatic and aromatic alcohols of C₁₀-C₂₀, aliphatic and aromatic esters of C₁₀-C₂₀, aliphatic and aromatic esters of C₁₀-C₂₀, silicone oils, natural and synthetic oils.

8. The method of claim 1, wherein in step (a), the emulsifier is used in an amount of 0.01 to 5.0 parts by weight, the ultrahydrophobe in an amount of 0.1 to 10 parts by weight, the hydrophobic material in an amount of 10 to 300 parts by weight, and the initiator in an amount of 0.01 to 3 parts by weight, based on 100 parts by weight of the free-radically polymerizable and ethylenically unsaturated monomer.

9. The method of claim 2, wherein the emulsifier is used in an amount of 0.01 to 5.0 parts by weight, the ultrahydrophobe in an amount of 0.1 to 10 parts by weight, the hydrophobic material in an amount of 10 to 300 parts by weight, the crosslinking agent in an amount of 0.1 to 10 parts by weight, and the initiator in an amount of 0.01 to 3 parts by weight, based on 100 parts by weight of the free-radically polymerizable and ethylenically unsaturated monomer.

10. The method of claim 4, wherein the emulsifier is used in an amount of 0.01 to 5.0 parts by weight, the ultrahydrophobe in an amount of 0.1 to 10 parts by weight, the hydrophilic comonomer in an amount of 0.1 to 10 parts by weight, the hydrophobic material in an amount of 10 to 300 parts by weight, the crosslinking agent in an amount of 0.1 to 10 parts by weight, the oil-soluble initiator in an amount of 0.01 to 3 parts by weight, and the secondary initiator in an amount of 0.01 to 1 part by weight, based on 100 parts by weight of the free-radically and polymerizable ethylenically unsaturated monomer.

11. The method of claim 1, wherein polymerizing the miniemulsion is performed at a temperature of 25 to 160° C. for 3 to 24 hours.

12. The method of claim 1, wherein the free-radically polymerizable and ethylenically unsaturated monomer is one or more selected from the group consisting of methacrylate derivatives, acrylate derivatives, acrylic acid derivatives, methacrylonitriles, ethylenes, butadienes, isoprenes, styrenes, styrene derivatives, acrylonitrile derivatives, vinylester derivatives, and halogenated vinyl derivatives, and mercaptan derivatives.

13. The method of claim 1, wherein the emulsifier is one or more selected from the group consisting of a nonionic emulsifier, a cationic emulsifier, an anionic emulsifier and an amphiphilic emulsifier.

14. The method of claim 1, wherein the ultrahydrophobe is a strong hydrophobic material having solubility of 5×10⁻⁶ g/kg or less in 25° C. water

15. The method of claim 14, wherein the ultrahydrophobe is one or more selected from the group consisting of aliphatic hydrocarbons of C₁₂-C₂₀, aliphatic alcohols of C₁₂-C₂₀, alkylacrylates of C₁₂-C₂₀, alkyl mercaptans of C₁₂-C₂₀, organic dyes, fluorinated alkanes, silicone oils, natural and synthetic oils, oligomers with a molecular weight of 1,000 to 500,000, and polymers with a molecular weight of 1,000 to 500,000.

16. The method of claim 2, wherein the crosslinking agent is a monomer having two or more unsaturated bonds copolymerizable with the free-radically polymerizable and ethylenically unsaturated monomer.

17. The method of claim 16, wherein the crosslinking agent is one or more selected from the group consisting of allyl methacrylate, ethylene glycol dimethacrylate, ethylene glycol diacrylate, butanediol diacrylate, butanediol dimethacrylate, neopentyl glycol dimethacrylate, hexanediol dimethacrylate, triethylene glycol dimethacrylate, tetraethylene glycol dimethacrylate, trimethylolpropane trimethacrylate, pentaerythritol tetramethacrylate, and divinylbenzene.

18. The method of claim 1, wherein the initiator is one or more selected from the group consisting of peroxides, persulfates, azo compounds, and redox compounds.

19. The method of claim 4, wherein the oil-soluble initiator is a material having solubility of 0.5 g/kg or less in 25° C. water.

20. The method of claim 19, wherein the oil-soluble initiator is selected from the group consisting of peroxides, persulfates, azo compounds, and redox compounds.

21. The method of claim 4, wherein the hydrophilic comonomer is copolymerizable with the free-radically polymerizable and ethylenically unsaturated monomer to increase hydrophilicity of a polymer produced by copolymerization with the free-radically polymerizable and ethylenically unsaturated monomer so that the hydrophobic material used as a core material is stably positioned within a shell made of the polymer.

22. The method of claim 21, wherein the hydrophilic comonomer is one or more selected from unsaturated carboxylic acids selected from the group consisting of acrylic acid, methacrylic acid, itaconic acid, crotonic acid, fumaric acid and maleic acid; and unsaturated polycarboxylic acid alkyl esters having at least one carboxyl group selected from the group consisting of itaconic acid monoethyl ester, fumaric acid monobutyl ester and maleic acid monobutyl ester.

23. The method of claim 5, wherein the secondary initiator is one or more selected from the group consisting of peroxides, persulfates, azo compounds, and redox compounds.

24. The method of claim 5, wherein the secondary initiator is added when a monomer to polymer conversion is 50 to 95%.

25. The method of claim 3, wherein the crosslinking agent is added when a monomer to polymer conversion is 20 to 90%.

26. Microcapsules prepared by the method of claim 1.

27. The microcapsules of claim 26, wherein the microcapsules are composed of 10 to 80% by volume of a core made of the hydrophobic material, based on the total volume of the microcapsules, and a polymer shell surrounding the core, and have a particle size of 100 to 2,500 nm.

28. The microcapsules of claim 26, wherein the microcapsules are hollow, gas-filled microcapsules in which the hydrophobic material is removed.

29. The method of claim 2, wherein the hydrophobic material is compatible with the free-radically polymerizable and ethylenically unsaturated monomer and incompatible with a polymer constituting final shells of the microcapsules, and an interfacial tension between the hydrophobic material and water is larger than that between the polymer and water.

30. The method of claim 3, wherein the hydrophobic material is compatible with the free-radically polymerizable and ethylenically unsaturated monomer and incompatible with a polymer constituting final shells of the microcapsules, and an interfacial tension between the hydrophobic material and water is larger than that between the polymer and water.

31. The method of claim 4, wherein the hydrophobic material is compatible with the free-radically polymerizable and ethylenically unsaturated monomer and incompatible with a polymer constituting final shells of the microcapsules, and an interfacial tension between the hydrophobic material and water is larger than that between the polymer and water.

32. The method of claim 5, wherein the hydrophobic material is compatible with the free-radically polymerizable and ethylenically unsaturated monomer and incompatible with a polymer constituting final shells of the microcapsules, and an interfacial tension between the hydrophobic material and water is larger than that between the polymer and water.

33. The method of claim 29, wherein the hydrophobic material is one or more selected from the group consisting of aliphatic and aromatic hydrocarbons of C₄-C₂₀ and isomers thereof, aliphatic and aromatic alcohols of C₁₀-C₂₀, aliphatic and aromatic esters of C₁₀-C₂₀, aliphatic and aromatic esters of C₁₀-C₂₀, silicone oils, natural and synthetic oils.

34. The method of claim 30, wherein the hydrophobic material is one or more selected from the group consisting of aliphatic and aromatic hydrocarbons of C₄-C₂₀ and isomers thereof, aliphatic and aromatic alcohols of C₁₀-C₂₀, aliphatic and aromatic esters of C₁₀-C₂₀, aliphatic and aromatic esters of C₁₀-C₂₀, silicone oils, natural and synthetic oils.

35. The method of claim 31, wherein the hydrophobic material is one or more selected from the group consisting of aliphatic and aromatic hydrocarbons of C₄-C₂₀ and isomers thereof, aliphatic and aromatic alcohols of C₁₀-C₂₀, aliphatic and aromatic esters of C₁₀-C₂₀, aliphatic and aromatic esters of C₁₀-C₂₀, silicone oils, natural and synthetic oils.

36. The method of claim 32, wherein the hydrophobic material is one or more selected from the group consisting of aliphatic and aromatic hydrocarbons of C₄-C₂₀ and isomers thereof, aliphatic and aromatic alcohols of C₁₀-C₂₀, aliphatic and aromatic esters of C₁₀-C₂₀, aliphatic and aromatic esters of C₁₀-C₂₀, silicone oils, natural and synthetic oils.

37. The method of claim 3, wherein the emulsifier is used in an amount of 0.01 to 5.0 parts by weight, the ultrahydrophobe in an amount of 0.1 to 10 parts by weight, the hydrophobic material in an amount of 10 to 300 parts by weight, the crosslinking agent in an amount of 0.1 to 10 parts by weight, and the initiator in an amount of 0.01 to 3 parts by weight, based on 100 parts by weight of the free-radically polymerizable and ethylenically unsaturated monomer.

38. The method of claim 5, wherein the emulsifier is used in an amount of 0.01 to 5.0 parts by weight, the ultrahydrophobe in an amount of 0.1 to 10 parts by weight, the hydrophilic comonomer in an amount of 0.1 to 10 parts by weight, the hydrophobic material in an amount of 10 to 300 parts by weight, the crosslinking agent in an amount of 0.1 to 10 parts by weight, the oil-soluble initiator in an amount of 0.01 to 3 parts by weight, and the secondary initiator in an amount of 0.01 to 1 part by weight, based on 100 parts by weight of the free-radically and polymerizable ethylenically unsaturated monomer.

39. The method of claim 2, wherein polymerizing the miniemulsion is performed at a temperature of 25 to 160° C. for 3 to 24 hours.

40. The method of claim 3, wherein polymerizing the miniemulsion is performed at a temperature of 25 to 160° C. for 3 to 24 hours.

41. The method of claim 4, wherein polymerizing the miniemulsion is performed at a temperature of 25 to 160° C. for 3 to 24 hours.

42. The method of claim 5, wherein polymerizing the miniemulsion is performed at a temperature of 25 to 160° C. for 3 to 24 hours.

43. The method of claim 2, wherein the free-radically polymerizable and ethylenically unsaturated monomer is one or more selected from the group consisting of methacrylate derivatives, acrylate derivatives, acrylic acid derivatives, methacrylonitriles, ethylenes, butadienes, isoprenes, styrenes, styrene derivatives, acrylonitrile derivatives, vinylester derivatives, and halogenated vinyl derivatives, and mercaptan derivatives.

44. The method of claim 3, wherein the free-radically polymerizable and ethylenically unsaturated monomer is one or more selected from the group consisting of methacrylate derivatives, acrylate derivatives, acrylic acid derivatives, methacrylonitriles, ethylenes, butadienes, isoprenes, styrenes, styrene derivatives, acrylonitrile derivatives, vinylester derivatives, and halogenated vinyl derivatives, and mercaptan derivatives.

45. The method of claim 4, wherein the free-radically polymerizable and ethylenically unsaturated monomer is one or more selected from the group consisting of methacrylate derivatives, acrylate derivatives, acrylic acid derivatives, methacrylonitriles, ethylenes, butadienes, isoprenes, styrenes, styrene derivatives, acrylonitrile derivatives, vinylester derivatives, and halogenated vinyl derivatives, and mercaptan derivatives.

46. The method of claim 5, wherein the free-radically polymerizable and ethylenically unsaturated monomer is one or more selected from the group consisting of methacrylate derivatives, acrylate derivatives, acrylic acid derivatives, methacrylonitriles, ethylenes, butadienes, isoprenes, styrenes, styrene derivatives, acrylonitrile derivatives, vinylester derivatives, and halogenated vinyl derivatives, and mercaptan derivatives.

47. The method of claim 2, wherein the emulsifier is one or more selected from the group consisting of a nonionic emulsifier, a cationic emulsifier, an anionic emulsifier and an amphiphilic emulsifier.

48. The method of claim 3, wherein the emulsifier is one or more selected from the group consisting of a nonionic emulsifier, a cationic emulsifier, an anionic emulsifier and an amphiphilic emulsifier.

49. The method of claim 4, wherein the emulsifier is one or more selected from the group consisting of a nonionic emulsifier, a cationic emulsifier, an anionic emulsifier and an amphiphilic emulsifier.

50. The method of claim 5, wherein the emulsifier is one or more selected from the group consisting of a nonionic emulsifier, a cationic emulsifier, an anionic emulsifier and an amphiphilic emulsifier.

51. The method of claim 2, wherein the ultrahydrophobe is a strong hydrophobic material having solubility of 5×10⁻⁶ g/kg or less in 25° C. water

52. The method of claim 3, wherein the ultrahydrophobe is a strong hydrophobic material having solubility of 5×10⁻⁶ g/kg or less in 25° C. water

53. The method of claim 4, wherein the ultrahydrophobe is a strong hydrophobic material having solubility of 5×10⁻⁶ g/kg or less in 25° C. water

54. The method of claim 5, wherein the ultrahydrophobe is a strong hydrophobic material having solubility of 5×10⁻⁶ g/kg or less in 25° C. water

55. The method of claim 51, wherein the ultrahydrophobe is one or more selected from the group consisting of aliphatic hydrocarbons of C₁₂-C₂₀, aliphatic alcohols of C₁₂-C₂₀, alkylacrylates of C₁₂-C₂₀, alkyl mercaptans of C₁₂-C₂₀, organic dyes, fluorinated alkanes, silicone oils, natural and synthetic oils, oligomers with a molecular weight of 1,000 to 500,000, and polymers with a molecular weight of 1,000 to 500,000.

56. The method of claim 52, wherein the ultrahydrophobe is one or more selected from the group consisting of aliphatic hydrocarbons of C₁₂-C₂₀, aliphatic alcohols of C₁₂-C₂₀, alkylacrylates of C₁₂-C₂₀, alkyl mercaptans of C₁₂-C₂₀, organic dyes, fluorinated alkanes, silicone oils, natural and synthetic oils, oligomers with a molecular weight of 1,000 to 500,000, and polymers with a molecular weight of 1,000 to 500,000.

57. The method of claim 53, wherein the ultrahydrophobe is one or more selected from the group consisting of aliphatic hydrocarbons of C₁₂-C₂₀, aliphatic alcohols of C₁₂-C₂₀, alkylacrylates of C₁₂-C₂₀, alkyl mercaptans of C₁₂-C₂₀, organic dyes, fluorinated alkanes, silicone oils, natural and synthetic oils, oligomers with a molecular weight of 1,000 to 500,000, and polymers with a molecular weight of 1,000 to 500,000.

58. The method of claim 54, wherein the ultrahydrophobe is one or more selected from the group consisting of aliphatic hydrocarbons of C₁₂-C₂₀, aliphatic alcohols of C₁₂-C₂₀, alkylacrylates of C₁₂-C₂₀, alkyl mercaptans of C₁₂-C₂₀, organic dyes, fluorinated alkanes, silicone oils, natural and synthetic oils, oligomers with a molecular weight of 1,000 to 500,000, and polymers with a molecular weight of 1,000 to 500,000.

59. The method of claim 3, wherein the crosslinking agent is a monomer having two or more unsaturated bonds copolymerizable with the free-radically polymerizable and ethylenically unsaturated monomer.

60. The method of claim 4, wherein the crosslinking agent is a monomer having two or more unsaturated bonds copolymerizable with the free-radically polymerizable and ethylenically unsaturated monomer.

61. The method of claim 5, wherein the crosslinking agent is a monomer having two or more unsaturated bonds copolymerizable with the free-radically polymerizable and ethylenically unsaturated monomer.

62. The method of claim 59, wherein the crosslinking agent is one or more selected from the group consisting of allyl methacrylate, ethylene glycol dimethacrylate, ethylene glycol diacrylate, butanediol diacrylate, butanediol dimethacrylate, neopentyl glycol dimethacrylate, hexanediol dimethacrylate, triethylene glycol dimethacrylate, tetraethylene glycol dimethacrylate, trimethylolpropane trimethacrylate, pentaerythritol tetramethacrylate, and divinylbenzene.

63. The method of claim 60, wherein the crosslinking agent is one or more selected from the group consisting of allyl methacrylate, ethylene glycol dimethacrylate, ethylene glycol diacrylate, butanediol diacrylate, butanediol dimethacrylate, neopentyl glycol dimethacrylate, hexanediol dimethacrylate, triethylene glycol dimethacrylate, tetraethylene glycol dimethacrylate, trimethylolpropane trimethacrylate, pentaerythritol tetramethacrylate, and divinylbenzene.

64. The method of claim 61, wherein the crosslinking agent is one or more selected from the group consisting of allyl methacrylate, ethylene glycol dimethacrylate, ethylene glycol diacrylate, butanediol diacrylate, butanediol dimethacrylate, neopentyl glycol dimethacrylate, hexanediol dimethacrylate, triethylene glycol dimethacrylate, tetraethylene glycol dimethacrylate, trimethylolpropane trimethacrylate, pentaerythritol tetramethacrylate, and divinylbenzene.

65. The method of claim 2, wherein the initiator is one or more selected from the group consisting of peroxides, persulfates, azo compounds, and redox compounds.

66. The method of claim 3, wherein the initiator is one or more selected from the group consisting of peroxides, persulfates, azo compounds, and redox compounds.

67. The method of claim 5, wherein the oil-soluble initiator is a material having solubility of 0.5 g/kg or less in 25° C. water.

68. The method of claim 67, wherein the oil-soluble initiator is selected from the group consisting of peroxides, persulfates, azo compounds, and redox compounds.

69. The method of claim 5, wherein the hydrophilic comonomer is copolymerizable with the free-radically polymerizable and ethylenically unsaturated monomer to increase hydrophilicity of a polymer produced by copolymerization with the free-radically polymerizable and ethylenically unsaturated monomer so that the hydrophobic material used as a core material is stably positioned within a shell made of the polymer.

70. The method of claim 69, wherein the hydrophilic comonomer is one or more selected from unsaturated carboxylic acids selected from the group consisting of acrylic acid, methacrylic acid, itaconic acid, crotonic acid, fumaric acid and maleic acid; and unsaturated polycarboxylic acid alkyl esters having at least one carboxyl group selected from the group consisting of itaconic acid monoethyl ester, fumaric acid monobutyl ester and maleic acid monobutyl ester.

71. Microcapsules prepared by the method of claim 2.

72. Microcapsules prepared by the method of claim 3.

73. Microcapsules prepared by the method of claim 4.

74. Microcapsules prepared by the method of claim 5.

75. The microcapsules of claim 71, wherein the microcapsules are composed of 10 to 80% by volume of a core made of the hydrophobic material, based on the total volume of the microcapsules, and a polymer shell surrounding the core, and have a particle size of 100 to 2,500 nm.

76. The microcapsules of claim 72, wherein the microcapsules are composed of 10 to 80% by volume of a core made of the hydrophobic material, based on the total volume of the microcapsules, and a polymer shell surrounding the core, and have a particle size of 100 to 2,500 nm.

77. The microcapsules of claim 73, wherein the microcapsules are composed of 10 to 80% by volume of a core made of the hydrophobic material, based on the total volume of the microcapsules, and a polymer shell surrounding the core, and have a particle size of 100 to 2,500 nm.

78. The microcapsules of claim 74, wherein the microcapsules are composed of 10 to 80% by volume of a core made of the hydrophobic material, based on the total volume of the microcapsules, and a polymer shell surrounding the core, and have a particle size of 100 to 2,500 nm.

79. The microcapsules of claim 71, wherein the microcapsules are hollow, gas-filled microcapsules in which the hydrophobic material is removed.

80. The microcapsules of claim 72, wherein the microcapsules are hollow, gas-filled microcapsules in which the hydrophobic material is removed.

81. The microcapsules of claim 73, wherein the microcapsules are hollow, gas-filled microcapsules in which the hydrophobic material is removed.

82. The microcapsules of claim 74, wherein the microcapsules are hollow, gas-filled microcapsules in which the hydrophobic material is removed.
